(19) United States
(12) Patent Application Publication
(10) Pub. No.: US 2024/0010571 A1
(43) Pub. Date: Jan. 11, 2024

(54) ELABORATION OF CERAMIC MATERIALS MADE FROM REFRACTORY WASTE FOR HIGH-TEMPERATURE THERMAL ENERGY STORAGE APPLICATIONS

(71) Applicants: Mike James TINER, Austin, TX (US); SERAMIC MATERIALS LIMITED, Abu Dhabi (AE)

(72) Inventors: Mike James TINER, Austin, TX (US); Jean-Francois HOFFMANN, Abu Dhabi (AE)

(73) Assignee: SERAMIC MATERIALS LIMITED, Abu Dhabi (AE)

(21) Appl. No.: 18/044,602

(22) PCT Filed: Aug. 27, 2021
(86) PCT No.: PCT/US2021/048032

§ 371 Date: Mar. 9, 2023

Related U.S. Application Data
(60) Provisional application No. 63/076,064, filed on Sep. 9, 2020.

(30) Foreign Application Priority Data
Nov. 30, 2020 (FR) 2012429

(51) Int. Cl. C04B 35/622; C04B 41/00; C04B 35/63

(52) U.S. Cl. CPC C04B 35/62204; C04B 41/0072; C04B 35/6316; C04B 2235/6567; C04B 2235/9607

(57) ABSTRACT

A shaped thermal energy storage ceramic and its method of preparation including milling refractory waste exhibiting a diameter of 1 mm or less to form powder, sieving the powder to retain the powder having a particle size below 250 um, combining with a binder as clay or polymer, and water to form at least one of an extrudable paste and a granulated mixture, forming a green body from at least one of an extrudable paste and a granulated mixture, drying the green body, firing the green body to form the ceramic product at a temperature in the range of 1000 deg C. to 1400 deg C. for a time period in the range of 0.5 hours to 12 hours, and cooling the ceramic product.

### FIELD

The present disclosure is directed to a high-temperature thermal energy storage ceramic material made from recycled refractory waste and a preparation method of manufacturing such a ceramic.

### BACKGROUND OF THE INVENTION

According to the US Department of Energy, the industrial sector accounts for about one-third of the world total energy consumed and consequently is responsible for about one-third of fossil-fuel-related greenhouse gas emissions. It is estimated that somewhere between 20% to 50% of industrial energy input is lost as waste heat in the form of hot exhaust gases. As the industrial sector continues efforts to improve its energy efficiency, recovering heat losses provides an attractive opportunity for an emission-free and cheaper energy resource. Waste heat recovery (WHR) methods include heat collection and transport using heat transfer fluids (gases and/or liquids), and heat production for process heat, power generation, or cooling.

To transfer heat from continuous exhaust gases at high temperature (>1000° C.), some heat exchangers and regenerators (functioning as buffer storage) technical solutions have been developed. The regenerator consists of two thermal chambers through which hot and cold gases flow alternately. The two chambers are used in the way that one stores heat from the exhaust gases and the second transfers heat to the combustion air (efficiency of a burner increases with temperature of the combustion air). For intermittent exhaust gases, like batch processes, the unique solution is to use a thermal energy storage (TES) system to facilitate continuous power generation or process heat re-use. Major drawbacks of regenerators and TES systems used in heavy industry are the large size and capital costs. The previous technologies use exhaust gases or air because conventional thermal oil or molten salt have a limited temperature range (<400° C. for synthetic oil and <600° C. for molten salt) and present significant drawbacks (hazard classification, flammability), which limit their applicability in heavy industry.

Energy supply has always been a major issue, all the more so now that fossil fuels are becoming increasingly scarce, and with rising concerns about global warming. One solution that has emerged is the development of renewable energy technologies. Renewable energy sources are theoretically inexhaustible, so they can supply the global population for, at least, a very long time. Concentrated Solar Power (CSP) is one of the most promising renewable energy technologies, since solar radiation is available worldwide, and thanks to thermal energy storage, can produce continuously. Unlike photovoltaic technology, which produces electricity directly from sunlight, CSP first produces heat that can be directly used or transformed into electricity thanks to a Rankine power cycle. Since thermal energy is easier to store compared to electricity, it is theoretically possible to overcome problems of energy source intermittency, generate electricity at a constant power, and increase plant capacity factor.

Usually, commercial CSP plants use a two-tank molten salt system to store thermal energy. When the solar resource exceeds the power block needs, a part of the heat transfer fluid, generally synthetic oil, is diverted into a heat exchanger to transfer the heat to a more appropriate fluid for energy storage, generally molten salts. The latter is then stored in a tank called the hot tank. When there is a need for more energy than the solar radiation can provide, because of clouds or low sun elevation, the thermal energy storage fluid discharges the energy stored. To do so, it flows through the same heat exchanger and then is stored in another tank called the cold tank. This solution is almost always chosen because of its effectiveness and easiness to handle. Although two tanks are used, the heat transfer fluid volume is roughly equal to the volume of one tank only, which means that one tank may be removed to reduce the TES unit cost. Indeed, this TES technology represents a high initial investment, between 15 and 20% of the total cost of the CSP plant, it is classified as hazardous (SEVESO) in Europe and has a limited working temperature range below 600° C.

One solution for both renewable energy and heavy industry sectors is to use a thermocline TES system with solid filler or structured media and a gas as heat transfer fluid. The thermocline system consists of a single tank, with a thermal separation dissociating the hot and cold regions. The tank has two different inlets according to the operating mode. Hot fluid, coming from the heat source enters the hot part of the tank during the charge mode and displaces progressively the thermal separation zone meanwhile cold fluid is extracted from the cold part of the tank. A thermal gradient called thermocline is thus created in the TES system, allowing thermal separation but expanding within the tank over time. The term thermocline comes from the oceanographic vocabulary. It represents the thermal transition zone between the upper and the deep waters. On either side of the thermocline zone, the temperatures are nearly identical whereas the temperature range in the thermocline itself is wide. With low thermal storage capacity heat transfer fluids, such as air, a solid storage matrix is installed in the single tank. This type of storage system is called thermocline thermal energy storage with solid materials. This system offers significant possibilities to reduce the installation cost compared to the two-tank molten salt technology and it is the solution for high temperature storage.

Despite a decrease of the cost from a two-tank to a single-tank TES system, the thermocline TES system is not yet enough competitive to be deployed in the industry sector. The solid materials, high-temperature ceramics, are costly as they have to withstand the temperature and achieve thermal and mechanical properties. Materials intended for this use are required to present the following properties: (i) high densities and specific heat, (ii) high resistance to heat and durability, (iii) High availability to sustain the potential market growth for thermal energy storage materials.

Ceramics in general, and especially refractory ceramics, can meet these requirements, as their durability at high temperature vastly exceeds those of other families of materials. However, specialized refractory ceramics may be too expansive for this use. Moreover, limited availability of certain ceramics (High Alumina or Zirconia-based refractories) could impede deployment of thermal energy storage systems. Hence, the R&D community postulated that developing ceramics produced from industrial wastes and by-products could present advantages of reducing environmental impacts associated with production of such materials, divert industrial wastes from landfill, and reduce costs of these recycled materials to the point where they can be successfully mass-produced to meet the needs of thermal energy storage materials.

### SUMMARY OF THE INVENTION

The present invention especially relates to the use of refractory wastes as a feedstock to produce purposefully designed thermal energy storage materials, intended to be used either as a filler in packed bed systems, or as a ceramic element for structured bed systems.

The present invention relates to a method of producing a ceramic product comprising:
collecting and sorting a feed stock containing refractory waste,
pretreating of the feed stock from at least of (1) iron/steel recovery, (2) recovery of non-ferrous material, (3) washing, (4) decontamination (e.g., sulfur, slags, dross, glass, dusts, coke), (5) sieving, (6) crushing, (7) milling, and (8) thermal treatment; so as to recover refractory material,
receiving as a first component material a first recovered refractory material;
receiving as a second component material a binder;
combining the first and second component materials with water to form at least one of (1) an extrudable paste and (2) a granulated mixture;
forming a green body from the at least one of (1) the extrudable paste after extrusion and (2) the granulated mixture;
drying the green body;
firing the green body to form the ceramic product at a temperature in the range of 1100° C. to 1400° C. for a time period in the range of 0.5 hours to 12 hours; and
cooling the ceramic product.

Advantageously, the ceramic product is a thermal energy storage ceramic product.

Advantageously, the first component material is at least one refractory waste selected from the group consisting of:
(1) Silica refractory waste, composed of following component: at least 93 wt. % of silicon dioxide (SiO₂), and inevitable impurities due to the waste nature from 0.01 to 5 wt. % of the composition;
(2) High Alumina refractory waste, composed of following component: at least 45 wt. % of aluminum oxide (Al₂O₃), and inevitable impurities due to the waste nature from 0.01 to 5 wt. % of the composition. This family includes ceramics such as sillimanite, mullite, bauxite, corundum;
(3) Magnesite refractory waste, composed of following component: at least 85 wt. % of magnesium oxide (MgO), and inevitable impurities due to the waste nature from 0.01 to 5 wt. % of the composition;
(4) Forsterite refractory waste, composed of following components: at least 60 wt. % MgO, from 15 wt. % to 20 wt. % of SiO₂, and inevitable impurities due to the waste nature from 0.01 to 5 wt. % of the composition;
(5) Dolomite refractory waste, composed of the following components: from 25 wt. % to 45 wt. % of MgO, from 35 wt. % to 65 wt. % of calcium oxide (CaO), and inevitable impurities due to the waste nature from 0.01 to 5 wt. % of the composition;
(6) Magnesia chrome refractory waste, composed of the following components: from 44 wt. % to 68 wt. % of MgO, from 16 wt. % to 25 wt. % of chromium oxide (Cr₂O₃), and inevitable impurities due to the waste nature from 0.01 to 5 wt. % of the composition;
(7) Magnesia carbon refractory waste, composed of the following components: from 80 wt. % to 93 wt. % of MgO, from 7 wt. % to 10 wt. % of graphite, and inevitable impurities due to the waste nature from 0.01 to 5 wt. % of the composition;
(8) Zirconia refractory waste, composed of the following component: at least 65 wt. % of zirconium oxide (ZrO₂), and inevitable impurities due to the waste nature from 0.01 to 5 wt. % of the composition;
(9) AZS refractory waste, composed of the following components: from 45 wt. % to 50 wt. % of Al₂O₃, from 30 wt. % to 35 wt. % of ZrO₂, from 14 wt. % to 16 wt. % of SiO₂, and inevitable impurities due to the waste nature from 0.01 to 5 wt. % of the composition;
(10) Insulating or fireclay refractory waste, composed of the following components: from 45 wt. % to 70 wt. % of SiO₂, from 25 wt. % to 45 wt. % of Al₂O₃, and inevitable impurities due to the waste nature from 0.01 to 5 wt. % of the composition;
(11) Silicon carbide refractory waste, composed of the following components: at least 82 wt. % of silicon carbide (SiC), and inevitable impurities due to the waste nature from 0.01 to 5 wt. % of the composition; and
(12) Boron nitride refractory waste, composed of the following components: at least 40 wt. % of boron nitride (BN), and inevitable impurities due to the waste nature from 0.01 to 5 wt. % of the composition.

Advantageously, the second component material is a binder selected from the group consisting of: natural clay and clay-like materials.

Preferably, the clay-like materials comprise, from at least one of ceramic, mining, and quarrying industries, at least one of dusts, sludges, and muds.

According to an advantageous embodiment, the first component material is at least 30% by weight of the first and second component materials.

According to another advantageous embodiment, the second component material is at least 20% by weight of the first and second component materials.

According to a first variant embodiment, the first component material is AZS refractory waste, and wherein the second component material is clay, and wherein the first and second component materials have relative weight of 70% and 30% respectively.

According to a second variant embodiment, the first component material is a combination of AZS refractory waste and high alumina refractory waste, and wherein the second component material is a clay-like material, and wherein AZS refractory waste, high alumina refractory waste and clay-like material have relative weights of 30%, 30% and 40% respectively. According to a third variant embodiment, the first component material is a combination of AZS refractory waste and magnesite refractory waste, and wherein the second component material is a clay-like material, and wherein AZS refractory waste, magnesite refractory waste and clay-like material have relative weights of 35%, 35% and 30% respectively.

The invention also concerns a ceramic product formed according to the method described previously.

Advantageously, the ceramic product may be a ceramic filler material in at least one of the following geometries: spheres, cylinders, Raschig rings, saddle rings, cross diaphragm rings, Pall rings, hollow or solid multilobe.

Advantageously, the ceramic product may be a ceramic structured media in at least one of the following geometries: honeycomb structures, wave plates, and channeled bricks.

The invention also concerns the use of a ceramic product as a thermal energy storage ceramic for storing heat up to 1400° C., the use of a ceramic filler materials in a packed bed thermal energy storage system or the use of a ceramic product as structured media in a thermal energy storage system.

The invention also concerns a thermal energy storage system comprising such a ceramic product.

### BRIEF DESCRIPTION OF THE DRAWINGS

FIG. 1 is flowchart showing a number of repeatable pre-treatment steps that may be applied to feed stocks prior to a number of the processing steps described herein.

FIG. 2 is a flowchart showing an extrusion technique for creating a ceramic product.

FIG. 3 is a flowchart showing a compaction technique for creating a ceramic product.

FIGS. 4A and 4B are pictures of the final thermal energy storage ceramic for the experimental example 1.

FIG. 5 is a picture of the final thermal energy storage ceramic for the experimental example 2.

### DETAILED DESCRIPTION OF THE INVENTION

As noted in the field, the present disclosure is directed to thermal energy storage ceramics and a method of forming such ceramics from mixtures of refractory wastes and Unfired Ceramic Raw Materials (clay and clay-like materials). The present invention further related to two different methods of forming the final products: (i) extrusion, and (ii) dry powder compaction process. The final products may be used in the fields of thermal energy storage, either as a thermal energy storage packed media or as ceramic elements for structured bed, depending on their shapes. They are characterized by specific properties such as thermal resistance, mechanical stability, density, specific heat and dimensional stability. These ceramics are intended to be used as refractory ceramics, especially for thermal energy storage applications.

All materials that will not be destroyed during firing and will therefore be constituents of the final ceramic product will be thereafter designated as feedstocks, which exclude organic and water-based additives. Preferentially, the feedstocks are refractory wastes, or mixtures of refractory wastes. It is also possible to replace one refractory waste in the mixtures by a commercial material when the industrial waste is locally unavailable.

The disclosed thermal energy storage ceramics are produced based on: (1) at least on refractory wastes comprises about 30% to about 80% of the mixture weight, and (2) Clay or Clay-like comprises about 20% to about 70% of the mixture weight.

Preferentially, the ceramic feedstock will contain some weight percent of Clay or Clay-like. Clay is a finely-grained natural rock/soil material combining one or more clay minerals (hydrous aluminum phyllosilicates), often in combination with quartz and metal oxides, in variable proportions from one deposit to another (especially including clay-like minerals such as bauxite). They are usually plastic when hydrated, and become hard, brittle and non-plastic when dried or fired. Depending on the engineering field, clay-containing materials can also be called silts or muds as a function of particle size. Clay is one of the favorite ceramic industry's feedstocks, due to its good workability when wet. The clay-like used will be preferentially sourced from discarded material in the ceramic industry (dusts, washing muds, surplus clay) or the mining and quarrying industries (dusts and washing muds). The clay and clay-like materials are designated as Unfired Raw Ceramic Material (URCM). URCM comprise, and preferably consists essentially of:
aluminum oxide (Al₂O₃): from 12 to 71 wt. %,
calcium oxide (CaO): from 0 to 10 wt. %,
iron oxide (Fe₂O₃): from 1 to 15 wt. %,
magnesium oxide (MgO): from 0.01 to 10 wt. %,
silicon dioxide (SiO₂): from 6 to 71 wt. %,
sodium oxide (Na₂O): from 0.01 to 3 wt. %,
potassium oxide (K₂O): from 0.01 to 10 wt. %,
optionally one or more of the following: from 0.01 to 20 wt. %.
MnO, P₂O₅, SOx, and TiO₂
   and inevitable impurities, wherein the wt. % is the weight percent relative to the total weight of the URCM mineral composition to provide, including the inevitable impurities, 100 wt. %. The inevitable impurities are, generally, unavoidable and are often a result of the process environment, feedstocks, or the natural deposit properties.

Preferentially, the ceramic formation will contain always some weight percent of refractory wastes. Refractory wastes are produced as by-products of industrial processes (e.g., steel, cement, glass, ceramic industries) or as by-products of refractory industries. In the former case, this refers to refractory materials that have been used, and are discarded after their service life (spent refractories). The latter case refers to refractory wastes produced during the manufacturing of refractory products (e.g., off-specs pieces, dusts and defective pieces, cutting residues). Many different families of refractory ceramics exist, and can be used to produce the thermal energy storage materials. These families are described thereafter.

Silica refractory waste, composed of following component: at least 93 wt. % of silicon dioxide (SiO₂), and inevitable impurities due to the waste nature from 0.01 to 5 wt. %, wherein the wt. % is the weight percent relative to the total weight of the composition.

High alumina refractory waste, composed of following component: at least 45 wt. % of aluminum oxide (Al₂O₃), and inevitable impurities due to the waste nature from 0.01 to 5 wt. %, wherein the wt. % is the weight percent relative to the total weight of the composition. This family includes ceramics such as sillimanite, mullite, bauxite, corundum;

Magnesite refractory waste, composed of following component: at least 85 wt. % of magnesium oxide (MgO), and inevitable impurities due to the waste nature from 0.01 to 5 wt. %, wherein the wt. % is the weight percent relative to the total weight of the composition.

Forsterite refractory waste, composed of following components: at least 60 wt. % MgO, from 15 wt. % to 20 wt. % of SiO₂, and inevitable impurities due to the waste nature from 0.01 to 5 wt. %, wherein the wt. % is the weight percent relative to the total weight of the composition.

Dolomite refractory waste, composed of the following components: from 25 wt. % to 45 wt. % of MgO, from 35 wt. % to 65 wt. % of calcium oxide (CaO), and inevitable impurities due to the waste nature from 0.01 to 5 wt. %, wherein the wt. % is the weight percent relative to the total weight of the composition.

Magnesia chrome refractory waste, composed of the following components: from 44 wt. % to 68 wt. % of MgO, from 16 wt. % to 25 wt. % of chromium oxide (Cr₂O₃), and inevitable impurities due to the waste nature from 0.01 to 5 wt. %, wherein the wt. % is the weight percent relative to the total weight of the composition.

Magnesia carbon refractory waste, composed of the following components: from 80 wt. % to 93 wt. % of MgO, from 7 wt. % to 10 wt. % of graphite, and inevitable impurities due to the waste nature from 0.01 to 5 wt. %, wherein the wt. % is the weight percent relative to the total weight of the composition.

Zirconia refractory waste, composed of the following component: at least 65 wt. % of zirconium oxide (ZrO₂), and inevitable impurities due to the waste nature from 0.01 to 5 wt. %, wherein the wt. % is the weight percent relative to the total weight of the composition.

AZS refractory waste, composed of the following components: from 45 wt. % to 50 wt. % of Al₂O₃, from 30 wt. % to 35 wt. % of ZrO₂, from 14 wt. % to 16 wt. % of SiO₂, and inevitable impurities due to the waste nature from 0.01 to 5 wt. %, wherein the wt. % is the weight percent relative to the total weight of the composition.

Insulating or fireclay refractory waste, composed of the following components: from 45 wt. % to 70 wt. % of SiO₂, from 25 wt. % to 45 wt. % of Al₂O₃, and inevitable impurities due to the waste nature from 0.01 to 5 wt. %, wherein the wt. % is the weight percent relative to the total weight of the composition.

Silicon Carbide refractory waste, composed of the following components: at least 82 wt. % of silicon carbide (SiC), and inevitable impurities due to the waste nature from 0.01 to 5 wt. %, wherein the wt. % is the weight percent relative to the total weight of the composition.

Boron Nitride refractory waste, composed of the following components: at least 40 wt. % of boron nitride (BN), and inevitable impurities due to the waste nature from 0.01 to 5 wt. %, wherein the wt. % is the weight percent relative to the total weight of the composition.

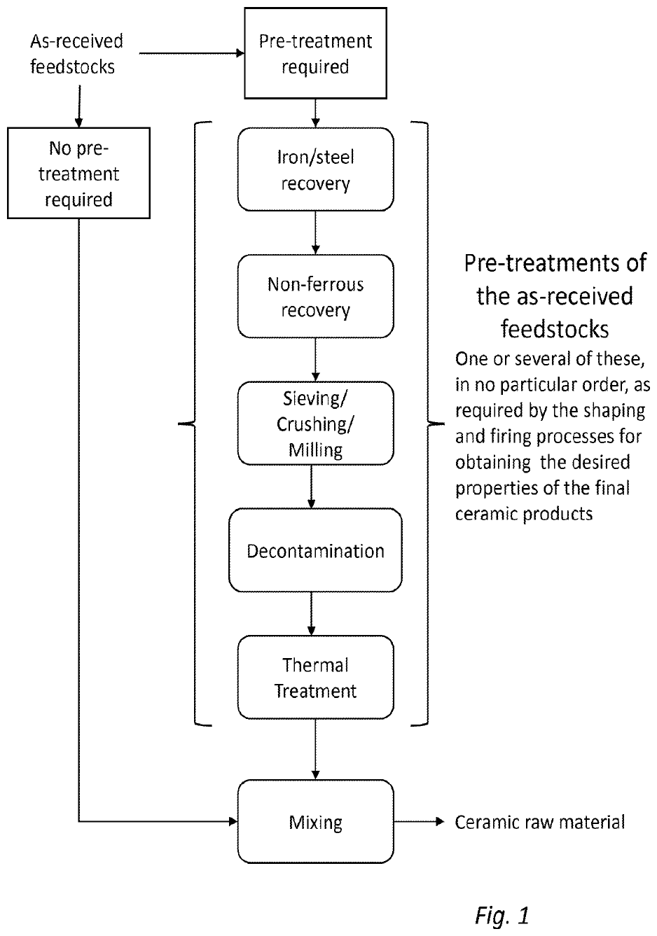

Pre-treatments, illustrated in flow chart of FIG. 1, is a general term regrouping process steps that are done prior to using the as-received material, generally to make the material more compatible with the requirements of the transformation process (i.e.: mixing, shaping, firing a ceramic), or to make the material easier to handle, store, and transport.

The presence of metals into a ceramic raw material can be detrimental, as metals can be reactive at high temperatures (oxidation or reduction, as an example). Moreover, their thermal dilatation coefficient being generally higher than the other constituents of a ceramic matrix surrounding them (e.g., alumino-silicates), they tend to fracture the matrix or produce cavities in the bulk of a green body during firing. Hence, iron and steel recovery from the feedstock could be advised. Iron and steel recovery processes are widespread and rely on the generation of a strong magnetic current over a conveyor. Iron-rich particles will be attracted by the magnet, and be removed from the feedstock. This treatment could be especially relevant to treat spent refractories from the metallurgy industries, which have a higher risk of being contaminated by metals or metal-rich slags.

Non-ferrous metals recovery also generally relies on the generation of a strong, varying magnetic field, called Eddy Current or Foucault Current. Metals react differently to this magnetic field: ferrous metals are attracted to it, while non-ferrous metals (aluminum and copper) are repulsed. By exposing the feedstock (on a conveyor, for example) not only the metals can be extracted from it, but also sorted. This process is widely used in waste-sorting facilities, typically to recover aluminum cans and copper wires from household wastes. For this particular application, it could be used to recover metal-rich slags, dusts and small particles from the feedstock.

Decontamination processes refers to processes designed to remove undesirable components from the feedstock, which might be detrimental for using it as a raw material for ceramic production (e.g., sulfur, slags, dross, glass, dusts, coke), and often rely on washing, vibration or heating. Decontamination processes will be chosen according to the nature and severity of the contamination.

The as-received feedstocks, which can exhibit widely different particle sizes (from broken refractories to a full refractory beam piece), are subjected to a milling or crushing process. Crushing consist in destroying a material by overwhelming compressive force or mechanical shock, allowing to transform a granular material into a finer one. However, the crushed material will most often present itself with a strongly heterogeneous shape. One of the most common crushing devices is called a jaw crusher. It is commonly used by the mineral industries (mining, quarrying, ceramic industries . . . ) to transform rocks into a workable gravel that can either be used as it is (ballast, filler, concrete rock agglomerate) or undergo further treatments such as milling. The particles feedstocks are preferably reduced to a powder size of 1 mm or less, wherein the size is the longest linear dimension of the powders. When using a commercial jaw crusher, the particles are preferably crushed for a period of time in the range of 0.2 hours to 4 hours including all values and ranges therein. After that, milling processes are used to produce particles with more homogeneous shape and roundness. Milling, also called grinding, rely more on attrition than on shock or compression to reduce particle size. Mills also are more prevalent for reducing particles to a smaller size than crushers. Depending on the grinding media and operational parameters, they can produce millimetric, micrometric, and sub-micronic powders. Ball mills are commonly used to grind clinker in cement industries, mineral ore in mining industries, or to produce fine et homogeneous powders or slurries for the ceramic industries (in the latter case, it is common practice to mill the materials diluted in water, sometimes with dispersant additives), but other technologies are available too (hammer mill, Raymond mill . . . ). The particles are preferably reduced to a powder size of 300 μm of less, wherein the size is the longest linear dimension of the powders. When using a commercial ball mill, the particles are preferably milled for a period of time in the range of 0.2 hours to 4 hours including all values and ranges therein.

Sieving consists in passing a granular material through a sieve with a fixed mesh. The particles smaller than the sieve gap will pass through, while wider ones will be retained at the surface of the mesh. It is common practice to use sieves in series, to retain certain fractions of a granular material. The crushed or milled powder is then sieved to obtain a homogenous mixture with particles sizes between 10 μm to 2 mm, including all values and ranges therein. Preferably for the ceramic's feedstocks mixing, the powders are screened to a size in the range of 20 to 400 μm.

The disclosed ceramics are produced based on several materials and feedstocks formulation that need to be mixed together prior to shaping. The feedstocks present themselves either as loose, dry powders or agglomerates, as a paste, or as a slurry. Depending on their properties, they will be mixed using rotary drums, rotary plates, pug mills, or any kind of mixer appropriate to their properties, according to the mixing ratios chosen for a particular application of the final ceramic. Preferably, the finest powders will be added first into the mix. Added water, if any, should be added progressively into the mixture, preferably by spraying during mixing. The goal of this process step is to produce a homogeneous mixture that can then be used as the raw ceramic material in the shaping step.

Shaping method consists in forming the raw ceramic materials to obtain a final product. The disclosed ceramic materials can be formed using two different methods, depending on the type of application for the desired ceramic, as well as the nature of the raw ceramic material. At this stage, the term “raw ceramic material” designates a homogeneous mixture of powders or a paste formed of the several feedstocks chosen. The present invention further related to two different methods of forming the final products: (i) extrusion and (ii) dry powder compaction process.

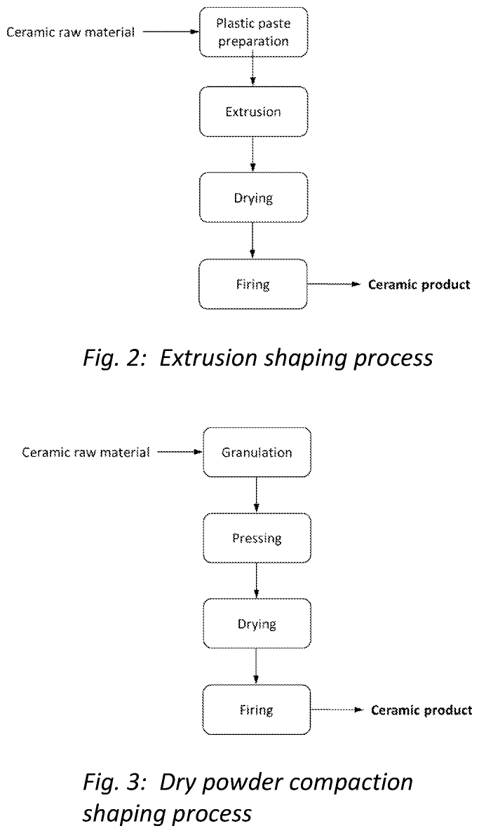

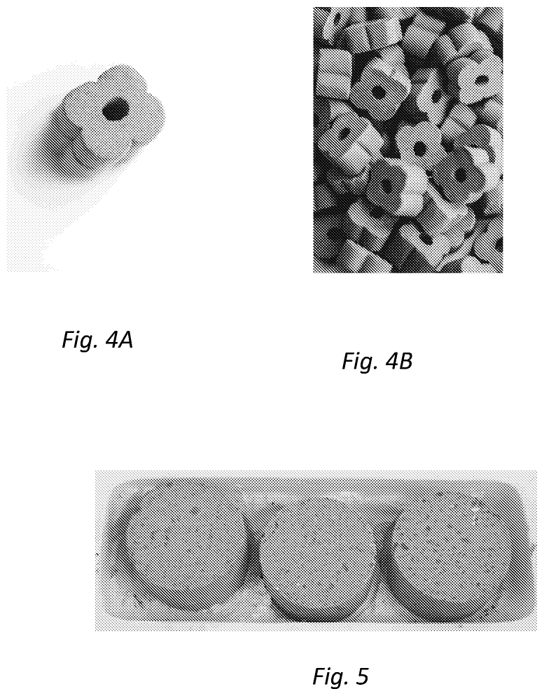

Preferably, a multi-step method for the extrusion method, illustrated in flow chart of FIG. 2, is used to form a thermal energy storage ceramic described herein, the method embodying: (1) preparation the ceramic raw material to obtain a plastic paste, then (2) shaping by extrusion to obtain a solid called green body, then (3) drying to remove the moisture content, and finally (4) firing at high temperature to get a ceramic product. This forming method is commonly used to process clay-containing raw ceramic materials to produce building bricks, roof and floor tiles, decorative and protective claddings, as well as a variety of specialty ceramics, including refractory ceramics.

The aforementioned ceramic raw materials present themselves as a mixture of powders or as a paste. The extrusion shaping method requiring a certain level of plasticity, adjusting the water content of the raw materials can be needed (this is especially relevant for clay-rich formulations, as moisture greatly impacts clay's behavior). At this stage of the process, additives can also be added to the mix. The function of the additives might be to increase plasticity (i.e., plasticizers), reduce friction inside the extruder (i.e., lubricants and release agents) or modify the behavior of the green body during firing (i.e., fluxing agents). The different raw materials, water and additives can be mixed together using a variety of systems, including rotating drums and pugmills (with or without vacuum pump), preferably adding the finest-grained raw materials first, and adding water and additives progressively to avoid the formation of clusters. Usually, plastic pastes contain in the range of 10 wt. % to 30 wt. % water of the total weight of the formulation, and the combined additives (plasticizers, temporary binders and lubricants, dispersants, flocculants, anti-foaming agents, etc. . . . ) are present in an amount within a range from 0 wt. % to 10 wt. % of the total weight of the formulation. Mixing should proceed until a homogeneous paste with satisfying plasticity is obtained, which can range from 0.25 to 4 hours.

At this point, the plastic paste is ready for extrusion. The prepared plastic paste is fed into the extruder's hopper, and pushed through the extruder's cylinder with either a ram, an endless screw or two parallel screws. Preferably, the extruder will be equipped with a vacuum pump, as the air trapped into the paste could adversely affect the properties of the extruded green body. The rotation speed of the screw or ram speed are to be adjusted depending on the properties of the paste and the desired output rate and is from 10 to 100 min⁻¹, including all values and ranges therein. Extruders can be equipped with a variety of auxiliary systems, including but not limited to spray outlets inside the cylinder to dispense lubricants and release agents, heating systems, cooling systems, pressure sensors, temperature sensors. The extruded green body exiting the die is then cut at the appropriate length.

After the extrusion, drying operation is done to the green body using purpose-built dryers, with monitored humidity. During the drying stage, in which the temperature is transitioned from room temperature (20 to 30° C.) to drying temperature in the range of 100° C. to 150° C., a relatively slow heating rate is used, the heating rate being in the range of 0.5 K/min to 5 K/min, and preferably at 2 K/min, including all values and ranges therein. The time of the drying stage is preferably between 12 to 72 hours, including all values and ranges therein, depending on the size of the green body and its moisture content. The purpose-built dryers could be closed or tunnel ovens.

After the drying, firing operation is performed to allow sintering and obtain a ceramic product. A temperature program including a preheating stage and a firing stage is preferably used. During the preheating stage, in which the temperature is transitioned from room temperature (20 to 25° C.) or the drying temperature to preheating temperature, a heating rate is used, the heating rate being in the range of 0.5 K/min to 20 K/min, and preferably at 2 K/min, including all values and ranges therein. The time of the preheating stage is preferably between 0.25 to 4 hours, including all values and ranges therein. As the preheating temperature ranges from about 100° C. to 900° C., the additives burn out if included in the preparation. The firing temperature is selected depending on the shape and the formulation, it will be comprised between 1000 and 1500° C. More preferably, the firing temperature will be comprised between 1100 and 1400° C. The heating rate from the preheating temperature to firing stage is preferably in the range from 0.5 K/min to 20 K/min, including all values and ranges therein, and more preferably at 2 K/min. The firing time or hold time is in the range of 0.5 hours to 8 hours, including all values and ranges therein. After firing, the ceramic product is cooled to room temperature or handling temperature. The cooling rate is preferably in the range of 1 K/min to 40 K/min, including all range and value therein.

Various process parameters in the extrusion method may affect the properties of the final ceramic, such parameters might include the formulation, screw speed, de-airing, preheating temperature and duration, heating rate, firing temperature and duration, and product shape.

Preferably, a multi-step method for the dry powder compaction method, illustrated in flow chart of FIG. 3, is used to form a thermal energy storage ceramic described herein, the method embodying: (1) preparation of the ceramic raw material called granulation, then (2) pressing to obtain a solid called green compact, then (3) drying to remove the moisture content, and finally (4) firing at high temperature to get a ceramic product. This forming method is used to process raw ceramic materials to produce building bricks, roof and floor tiles, decorative and protective claddings, as well as a variety of technical ceramics, including refractory pieces. Contrary to the extrusion shaping method, the pressing method is less depending on plasticity, making it sometimes a preferable choice to shape raw ceramics materials with low clay content.

The aforementioned ceramics raw materials present themselves as a mixture of powders, as a paste or as a slurry. Although the pressing methods can be less demanding than the extrusion regarding plasticity and cohesion, adjusting the water content of the raw materials can be needed. At this stage of the process, additives can also be added to the mix. The function of the additives might be to increase plasticity (i.e., plasticizers) or cohesion between particles (temporary binders), reduce friction inside the pressing mold (i.e., lubricants and release agents) or modify the behavior of the green body during firing (i.e., fluxing agents). Preferably, the resulting mixture will have lower moisture than the ones prepared for extrusion. Although it might be possible to press the raw ceramic materials directly as a powder or a slightly moist powder, it can be useful to granulate the material, especially if it presents itself as a dry mixture of loose powders. Granulation can be done using different methods like spray-drying, or rotary plate or drum moisturizing (depending if the raw materials present themselves as a slurry or as a dry powder, respectively). The movement, as well as the change in moisture, cause particles to agglomerate to form small granules. These granules are easier to handle than loose dry powders, and often also react better when pressed to form cohesive green bodies. The size of the desired granules, the duration of the process and the water content needed vastly depends on the raw material's nature, the size of the desired green body and the desired properties for the final ceramic. Usually, granules contain in the range of 0 wt. % to 10 wt. % water of the total weight of the formulation, and the combined additives (plasticizers, temporary binders and lubricants, dispersants, flocculants, anti-foaming agents . . . ) are present in an amount within a range from 0 wt. % to 10 wt. % of the total weight of the formulation. Mixing should proceed until homogeneous granules are obtained, which can range from 0.25 hours to 4 hours.

The pressing step consists in applying high pressure on the granules placed in a mold, which is in turn placed into a press. Two variant dry compaction process can be done to obtain a ceramic product: (i) cold pressing by three successive steps i.e., compaction at room temperature to obtain green bodies, then drying and firing process, and (ii) hot pressing in one step wherein the thermal treatment is combined with the pressing step. The pressing action can also be either uniaxial (i.e., the force is applied on a given direction) or isostatic (i.e., the force is applied from every direction). Preferably, the compressing pressure for the cold dry powder compaction falls in a range from 10 MPa to 300 MPa, including all values and range therein, and preferably 50 MPa to 200 MPa. Pressure should be preferentially applied at a steady rate, although it might be possible to hold pressure at low compaction pressure to allow eventual trapped air to vent out of the mold and allow the powder to reorganize. About the hot dry powder compaction, the compression pressure is in the range from 10 MPa to 300 MPa, including all values and range therein. The sintering temperature is in the range from 600° C. to 1300° C. with a sintering time in the range from 0.5 hour to 5 hours, and a heating rate between 1 K/min to 15 K/min, including all values and ranges therein.

After the cold dry powder compaction, drying operation is done to the green body using purpose-built dryers, with monitored humidity. During the drying stage, in which the temperature is transitioned from room temperature (20 to 30° C.) to drying temperature in the range of 100° C. to 150° C., a relatively slow heating rate is used, the heating rate being in the range of 0.5 K/min to 5 K/min, and preferably at 2 K/min, including all values and ranges therein. The time of the drying stage is preferably between 12 to 72 hours, including all values and ranges therein, depending on the size of the green body and its moisture content. The purpose-built dryers could be closed or tunnel ovens.

After the drying, firing operation is done to allow sintering temperature and obtain a ceramic product. A temperature program including a preheating stage and a firing stage is preferably used. During the preheating stage, in which the temperature is transitioned from room temperature (20 to 25° C.) or the drying temperature to preheating temperature, a heating rate is used, the heating rate being in the range of 0.5 K/min to 60 K/min, and preferably at 2 K/min, including all values and ranges therein. The time of the preheating stage is preferably between 0.25 to 4 hours, including all values and ranges therein. As the preheating temperature from about 100° C. to 900° C., the additives burn out if included in the preparation. The firing temperature is selected depending on the shape and the formulation, it will be comprised between 1000 and 1500° C. More preferably, the firing temperature will be comprised between 1100 and 1400° C. The heating rate from the preheating temperature to firing stage is preferably in the range from 0.5 K/min to 60 K/min, including all values and ranges therein, and more preferably at 2 K/min. The firing time or hold time is in the range of 0.5 hours to 8 hours, including all values and ranges therein. After firing, the ceramic product is cooled to room temperature or handling temperature. The cooling rate is preferably in the range of 1 K/min to 40 K/min, including all range and value therein.

Various process parameters in the dry powder compaction method may affect the properties of the final ceramic, such parameters might include the formulation, compaction pressure, preheating temperature and duration, heating rate, firing temperature and duration, and product shape.

The ceramic product described may be employed as thermal energy storage application as the ceramics can storage heat in the solid materials up to 1400° C. Although there is a wide variety of shapes that can be obtained, either through extrusion or dry powder compaction methods, thermal energy storage ceramics should be shaped in order increase thermal energy systems' efficiency. Thus, some shapes will be favored over others. The ceramic may be employed as filler materials in packed bed thermal energy storage system or structured (self-supporting) media in thermal energy storage system.

Preferably in filler materials, ceramic assumes one of the following geometries: spheres, cylinders, Raschig rings, saddle rings, cross diaphragm rings, Pall rings, hollow or solid multilobe.

Preferably in structured or self-supporting media, ceramic assumes one of the following geometries: honeycomb structures, wave plates, and channeled bricks.

### Experimental Example #1

### Extrusion: AZS Refractory Waste (70 wt. %), and Natural Clay (30 wt. %)

AZS refractory waste has been collected as production waste of a refractory recycling factory. The powder presented itself as a very thin, homogeneous white powder, with a particle size below 63 μm.

Natural clay has been collected in a quarry located in France. It presented itself as a fine, homogeneous, cluster-free yellow powder, with a small residual water content inferior to 3 wt. %, with a d₅₀ of around 15 μm. This as-received powder was dried 12 hours at 120° C.

The dry powders were mixed together according to this specific composition: 70 wt. % of AZS refractory waste, and 30 wt. % of natural clay. Water was added to form a plastic paste, by uniformly spraying the rotating mixture. To obtain a satisfying plastic paste, 0.25 dry wt. % of organic plasticizer was added in the preparation. The plastic paste was mixed during 0.5 hour using a rotary drum mixer. The moisture content obtained was 20 wt. %+/−3 wt. %/

The plastic pastes were de-aired, with a vacuum pump activated, into a two-stage single screw extruder equipped with a quadrilobe opening of 20 mm. The plastic pastes were then extruded to form hollow quadrilobe with a 20 mm of typical diameter, and cut at 10 mm length.

The green bodies were dried in a forced-venting oven (Nabertherm oven) at 120° C. with a holding time of 12 hours. The dried green bodies were sintered in an electrically heated muffle furnace at the firing temperature (Nabertherm muffle furnace). During the firing stage, in which the temperature is transitioned from room temperature (25° C.) to firing temperature at 1260° C.

The heating rate was 2 K/min and the firing time was 3 hours. After firing, the ceramic product is cooled to room temperature with a cooling rate of 2 K/min.

The relative densities and the maximal compressive strength until failure have been measured using Archimedes' method and a monitored uniaxial press. The final product containing 70 wt. % of AZS refractory waste, 30 wt. % of natural clay, and extruded with 0.25 dry wt. % of organic plasticizer, exhibited an average relative density of 2600 kg/m³, and an average compressive strength of 110 MPa. The specific heat capacity is 0.72 kJ/kg·K at 100° C. and 1.06 kJ/kg·K at 600° C. The properties have been measured using a Differential Scanning Calorimeter (DSC).

### Experimental Example #2

### Dry Powder Compaction: AZS Refractory Waste (30 wt. %), High Alumina Refractory Waste (30 wt. %), and Clay-Like (40 wt. %)

AZS refractory waste has been collected as production waste of a refractory recycling factory. The powder presented itself as a very thin, homogeneous white powder, with a particle size below 63 μm.

High alumina refractory waste (type mullite) has been collected as production waste of a glass industry. The material was crushed using a jaw crusher, and milled using a ball miller during 0.5 hour, and sieved using sieves and a sieve shaker. The final powder presented itself as a white powder, with a particle size below 45 μm.

A clay-like (waste clay), produced as a washing mud in a ceramic factory, was collected in a ceramic Effluent Treatment Plant (ETP). It presented itself as a thick, white mud constituted of fine particles, with a residual water content between 15 to 30 wt. %, with a d₅₀ of around 10 μm. Further milling was considered unnecessary. This as-received powder was also dried 24 hours at 120° C., and then de-agglomerated by friction.

The dry powders were mixed together according to this specific composition: 30 wt. % of AZS refractory waste, 30 wt. % of high alumina refractory waste, and 40 wt. % of clay-like. The powders were mixed together during 1 hour using an Eirich powder mixer.

The dry mixtures were then granulated using a rotary plate, under water spraying. The produced granules had a characteristic length in the range from 0.5 mm to 1 mm, and presented a moisture content of about 5 wt. %.

The granules were used to feed a cylindrical mold (diameter: 25 mm), which was then pressed to form the green bodies. The applied pressure was 50 MPa using a uniaxial hydraulic press (Carver). Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies were dried in a forced-venting oven (Nabertherm oven) at 120° C. with a holding time of 12 hours. The dried green bodies were sintered in an electrically heated muffle furnace at the firing temperature (Nabertherm muffle furnace). During the firing stage, in which the temperature is transitioned from room temperature (25° C.) to firing temperature at 1350° C. The heating rate was 2 K/min and the firing time was 2 hour. After firing, the ceramic product is cooled to room temperature with a cooling rate of 2 K/min.

The relative densities and the maximal compressive strength until failure have been measured using Archimedes' method and a monitored uniaxial press. The final product containing 30 wt. % of AZS refractory waste, 30 wt. % of high alumina refractory waste, and 40 wt. % of clay-like, exhibited an average relative density of 2750 kg/m³, and an average compressive strength of 120 MPa. The specific heat capacity is 0.74 kJ/kg·K at 100° C. and 1.09 kJ/kg·K at 600° C. The properties have been measured using a Differential Scanning Calorimeter (DSC).

### Experimental Example #3

### Dry Powder Compaction: AZS Refractory Waste (35 wt. %), Magnesite Refractory Waste (35 wt. %), and Clay-Like (30 wt. %)

AZS refractory waste has been collected as production waste of a refractory recycling factory. The powder presented itself as a very thin, homogeneous white powder, with a particle size below 63 μm.

Magnesite refractory waste has been collected as production waste of a metallurgy industry. The material was crushed using a jaw crusher, and milled using a ball miller during 0.5 hour, and sieved using sieves and a sieve shaker. The final powder presented itself as a grey powder, with a particle size below 180 μm.

A clay-like (waste clay), produced as a washing mud in a ceramic factory, was collected in a ceramic Effluent Treatment Plant (ETP). It presented itself as a thick, white mud constituted of fine particles, with a residual water content between 15 to 30 wt. %, with a d₅₀ of around 10 μm. Further milling was considered unnecessary. This as-received powder was also dried 24 hours at 120° C., and then de-agglomerated by friction.

The dry powders were mixed together according to this specific composition: 35 wt. % of AZS refractory waste, 35 wt. % of magnesite refractory waste, and 40 wt. % of clay-like. The powders were mixed together during 1 hour using an Eirich powder mixer.

The dry mixtures were then granulated using a rotary plate, under water spraying. The produced granules had a characteristic length in the range from 0.5 mm to 1 mm, and presented a moisture content of about 5 wt. %.

The granules were used to feed a cylindrical mold (diameter: 25 mm), which was then pressed to form the green bodies. The applied pressure was 200 MPa using a uniaxial hydraulic press (Carver). Samples were ejected using a mechanical piston coming from the bottom of the mold. The pressed samples exhibited a satisfying behavior during pressing, with limited defects (layering, swelling, transversal rupture, etc.) and did not require the addition of lubricants to be extracted properly.

The green bodies were dried in a forced-venting oven (Nabertherm oven) at 120° C. with a holding time of 12 hours. The dried green bodies were sintered in an electrically heated muffle furnace at the firing temperature (Nabertherm muffle furnace). During the firing stage, in which the temperature is transitioned from room temperature (25° C.) to firing temperature at 1260° C.

The heating rate was 2 K/min and the firing time was 2 hours. After firing, the ceramic product is cooled to room temperature with a cooling rate of 2 K/min.

The relative densities and the maximal compressive strength until failure have been measured using Archimedes' method and a monitored uniaxial press. The final product containing 35 wt. % of AZS refractory waste, 35 wt. % of magnesite refractory waste, and 40 wt. % of clay-like, exhibited an average relative density of 2550 kg/m³, and an average compressive strength of 70 MPa. The specific heat capacity is 0.85 kJ/kg·K at 100° C. and 1.16 kJ/kg·K at 600° C. The properties have been measured using a Differential Scanning Calorimeter (DSC).

1. A method of producing a ceramic product, such as a thermal energy storage ceramic product, comprising:
collecting and sorting a feed stock containing refractory waste, pretreating of the feed stock from at least of iron/steel recovery, recovery of nonferrous material, washing, decontamination (e.g., sulfur, slags, dross, glass, dusts, coke), sieving, crushing, milling, and thermal treatment;
receiving as a first component material a first recovered refractory material;
receiving as a second component material a binder;
combining the first and second component materials with water to form at least one of an extrudable paste and a granulated mixture;
forming a green body from the at least one of the extrudable paste after extrusion and the granulated mixture;
drying the green body;
firing the green body to form the ceramic product at a temperature in a range of 1100° C. to 1400° C. for a time period in the range of 0.5 hours to 12 hours; and
cooling the ceramic product.

2. The method as claimed in claim 1, wherein the first component material is at least one refractory waste selected from the group consisting of:
(1) Silica refractory waste, composed of following component: at least 93 wt. % of silicon dioxide (SiO₂), and inevitable impurities due to waste nature from 0.01 to 5 wt. % of the composition;
(2) High Alumina refractory waste, composed of following component: at least 45 wt. % of aluminum oxide (Al₂O₃), and inevitable impurities due to the waste nature from 0.01 to 5 wt. % of the composition. This family includes ceramics such as sillimanite, mullite, bauxite, corundum;
(3) Magnesite refractory waste, composed of following component: at least 85 wt. % of magnesium oxide (MgO), and inevitable impurities due to the waste nature from 0.01 to 5 wt. % of the composition;
(4) Forsterite refractory waste, composed of following components: at least 60 wt. % MgO, from 15 wt. % to 20 wt. % of SiO₂, and inevitable impurities due to the waste nature from 0.01 to 5 wt. % of the composition;
(5) Dolomite refractory waste, composed of the following components: from 25 wt. % to 45 wt. % of MgO, from 35 wt. % to 65 wt. % of calcium oxide (CaO), and inevitable impurities due to the waste nature from 0.01 to 5 wt. % of the composition;
(6) Magnesia chrome refractory waste, composed of the following components: from 44 wt. % to 68 wt. % of MgO, from 16 wt. % to 25 wt. % of chromium oxide (Cr₂O₃), and inevitable impurities due to the waste nature from 0.01 to 5 wt. % of the composition;
(7) Magnesia carbon refractory waste, composed of the following components: from 80 wt. % to 93 wt. % of MgO, from 7 wt. % to 10 wt. % of graphite, and inevitable impurities due to the waste nature from 0.01 to 5 wt. % of the composition;
(8) Zirconia refractory waste, composed of the following component: at least 65 wt. % of zirconium oxide (ZrO₂), and inevitable impurities due to the waste nature from 0.01 to 5 wt. % of the composition;
(9) AZS refractory waste, composed of the following components: from 45 wt. % to 50 wt. % of Al₂O₃, from 30 wt. % to 35 wt. % of ZrO₂, from 14 wt. % to 16 wt. % of SiO₂, and inevitable impurities due to the waste nature from 0.01 to 5 wt. % of the composition;
(10) Insulating or fireclay refractory waste, composed of the following components: from 45 wt. % to 70 wt. % of SiO₂, from 25 wt. % to 45 wt. % of Al₂O₃, and inevitable impurities due to the waste nature from 0.01 to 5 wt. % of the composition;
(11) Silicon carbide refractory waste, composed of the following components: at least 82 wt. % of silicon carbide (SiC), and inevitable impurities due to the waste nature from 0.01 to 5 wt. % of the composition; and
(12) Boron nitride refractory waste, composed of the following components: at least 40 wt. % of boron nitride (BN), and inevitable impurities due to the waste nature from 0.01 to 5 wt. % of the composition.

3. The method as claimed in claim 1, wherein the second component material is a binder selected from the group consisting of: natural clay and clay-like materials.

4. The method as claimed in claim 3, wherein the clay-like materials comprise, from at least one of ceramic, mining, and quarrying industries, at least one of dusts, sludges, and muds.

5. The method as claimed in claim 1, wherein the first component material is at least 30% by weight of the first and second component materials.

6. The method as claimed in claim 1, wherein the second component material is at least 20% by weight of the first and second component materials.

7. The method as claimed in claim 1, wherein the first component material is AZS refractory waste, and wherein the second component material is clay, and wherein the first and second component materials have relative weight of 70% and 30% respectively.

8. The method as claimed in claim 1, wherein the first component material is a combination of AZS refractory waste and high alumina refractory waste, and wherein the second component material is a clay-like material, and wherein AZS refractory waste, high alumina refractory waste and clay-like material have relative weights of 30%, 30% and 40% respectively.

9. The method as claimed in claim 1, wherein the first component material is a combination of AZS refractory waste and magnesite refractory waste, and wherein the second component material is a clay-like material, and wherein AZS refractory waste, magnesite refractory waste and clay-like material have relative weights of 35%, 35% and 30% respectively.

10. A ceramic product formed according to the method according to claim 1.

11. The ceramic product according to claim 10, wherein the ceramic product is a ceramic filler material in at least one of the following geometries: spheres, cylinders, Raschig rings, saddle rings, cross diaphragm rings, Pall rings, hollow or solid multilobe.

12. The ceramic product according to claim 10, wherein the ceramic product is a ceramic structured media in at least one of the following geometries: honeycomb structures, wave plates, and channeled bricks.

13. Use of a ceramic product according to claim 10 as a thermal energy storage ceramic for storing heat up to 1400° C., as ceramic filler materials in a packed bed thermal energy storage system, or as structured media in a thermal energy storage system.

14. A thermal energy storage system comprising a ceramic product according to claim 10.
